(19) United States
(12) Patent Application Publication
(10) Pub. No.: US 2025/0272624 A1
(43) Pub. Date: Aug. 28, 2025

(54) ELECTRIC VEHICLE RESCUE SYSTEM

(71) Applicant: TOYOTA JIDOSHA KABUSHIKI KAISHA, Toyota-shi (JP)

(72) Inventors: Shunsuke TAKAHASHI, Toyota-shi (JP); Yuki NAGANUMA, Toyota-shi (JP); Kazuma MIYAZAKI, Toyota-shi (JP); Kohei DOBASHI, Toyota-shi (JP); Kenji NONAKA, Toyota-shi (JP)

(73) Assignee: TOYOTA JIDOSHA KABUSHIKI KAISHA, Toyota-shi (JP)

(21) Appl. No.: 19/010,926

(22) Filed: Jan. 6, 2025

(30) Foreign Application Priority Data
Feb. 22, 2024 (JP) 2024-026008

(51) Int. Cl. G06Q 10/0631; B60L 53/57; B60L 53/62; B60L 53/65; B60L 53/68; B60L 53/80

(52) U.S. Cl. CPC G06Q 10/0631; B60L 53/57; B60L 53/62; B60L 53/65; B60L 53/68; B60L 53/80

(57) ABSTRACT

An electric vehicle rescue system includes: an electric vehicle including a detachable battery, the detachable battery being replaceable with a replacement battery and rechargeable by storing power supplied from an external power source; a server configured to receive a rescue request from the electric vehicle; and rescue-ready vehicles communicatively connected to the server, each of the rescue-ready vehicles being possible to be sent to the electric vehicle in response to the rescue request. Each of the rescue-ready vehicles includes the replacement battery, or the external power supply capable of charging the detachable battery of the electric vehicle. The server includes: a storage unit; a specifying unit; a first calculation unit; a second calculation unit; and a notification unit.

The present application claims priority to and incorporates by reference the entire contents of Japanese Patent Application No. 2024-026008 filed in Japan on Feb. 22, 2024.

### BACKGROUND

The present disclosure relates to an electric vehicle rescue system.

JP 2021-105946 discloses an electric vehicle rescue system for delivering energy to the source of the electric vehicle using a transportation device such as a drone in order to relieve the electric vehicle in the electricity shortage. In the configuration described in JP-A No. 2021-105946, the time until the transportation device arrives at the portable terminal carried by the user of the electric vehicle is transmitted.

### SUMMARY

In the configuration described in JP-A-2021-105946, although the time until the transport device arrives is known, the time until the rescue completion is not known, the user requesting rescue fear is hardly solved, there is room for improvement.

Especially in the vehicle which runs by the electric power of the detachable battery like the cartridge type battery, there are two types of the electric power replenishment system, namely the battery replacement and the external charging. For battery replacement and external charging, it is shorter to replace the battery for the time required for rescue work in the event of an electricity shortage. Therefore, it is assumed that the battery replacement is more as a request when the power is lost.

In this case, as a rescue vehicle capable of responding immediately after the rescue request, the rescue vehicle having a cartridge-type battery is not sufficient, although the time until the rescue vehicle arrives may be extended, this is not considered in the configuration described in JP-A-2021-105946.

There is a need for an electric vehicle rescue system capable of reducing the anxiety of the user of the electric vehicle when the electric vehicle traveling by the state of the detachable battery becomes an electricity shortage.

According to one aspect of the present disclosure, there is provided an electric vehicle rescue system including: an electric vehicle including a detachable battery, the detachable battery being replaceable with a replacement battery and rechargeable by storing power supplied from an external power source; a server configured to receive a rescue request from the electric vehicle; and rescue-ready vehicles communicatively connected to the server, each of the rescue-ready vehicles being possible to be sent to the electric vehicle in response to the rescue request, wherein each of the rescue-ready vehicles includes the replacement battery, or the external power supply capable of charging the detachable battery of the electric vehicle, and the server includes: a storage unit configured to store rescue vehicle information as information about the rescue-ready vehicle, the rescue vehicle information including: location information of the rescue-ready vehicle; and information indicating presence or absence of the replacement battery; a specifying unit configured to specify a responding candidate vehicle from the rescue-ready vehicles which satisfy a necessary condition for supplying electric power to the electric vehicle in response to reception of electricity shortage information as the rescue request, the electricity shortage information including location information of the electric vehicle and information indicating that the electric vehicle is in an electricity shortage state, and the responding candidate vehicle being specified based on the rescue vehicle information and the electricity shortage information; a first calculation unit configured to calculate a travel time for the responding candidate vehicle to arrive at a location of the electric vehicle based on the location information of the rescue-ready vehicle and the location information of the electric vehicle; a second calculation unit configured to calculate a work time from arrival of the rescue-ready vehicle to completion of power supply to the electric vehicle based on the necessary condition; and a notification unit configured to notify responding candidate information including the rescue vehicle information, the travel time and the work time to a transmission source of the electricity shortage information.

### BRIEF DESCRIPTION OF THE DRAWINGS

FIG. 1 is a diagram schematically illustrating an electric vehicle rescue system in an embodiment;

FIG. 2 is a block diagram illustrating a functional configuration of a server;

FIG. 3 is a sequence diagram illustrating a rescue process;

FIG. 4 is a flowchart showing a control flow in the electric vehicle;

FIG. 5 is a flowchart illustrating a control flow in the server; and

FIG. 6 is a flowchart showing a control flow in a vehicle capable of responding to rescue.

### DETAILED DESCRIPTION

Hereinafter, an electric vehicle rescue system according to an embodiment of the present disclosure will be specifically described. Note that the present disclosure is not limited to the embodiments described below.

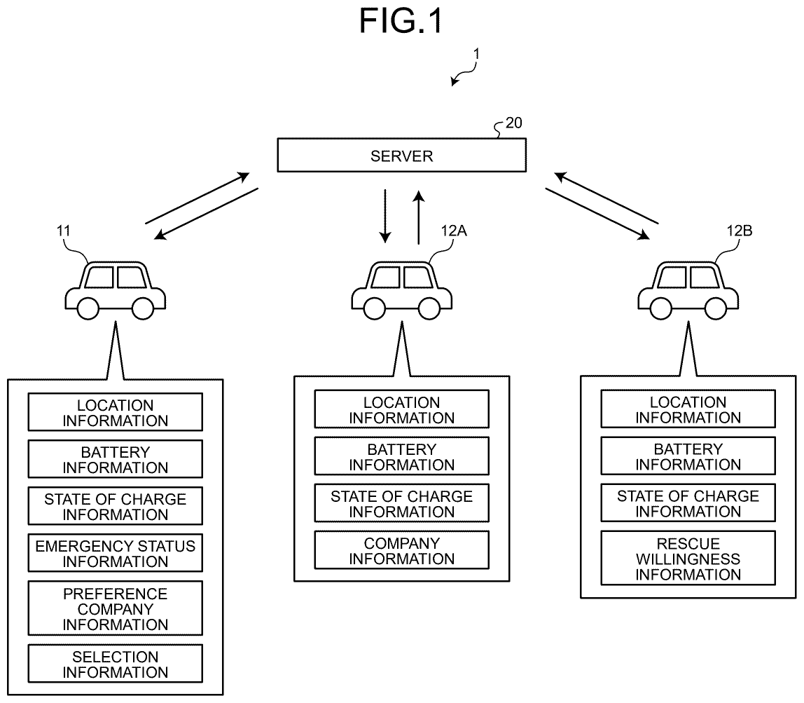

FIG. 1 is a diagram schematically illustrating an electric vehicle rescue system in an embodiment. The electric vehicle rescue system 1 is a system in which a plurality of electric vehicles 10 and a server 20 are communicably connected. The electric vehicle 10 includes an electric vehicle 11 that may be a rescue target and a rescue-ready vehicle 12. The electric vehicle rescue system 1, when the electric vehicle 11 equipped with a detachable battery becomes an electricity shortage, the electric vehicle 11 in the electricity shortage as a rescue object, in order to eliminate the electricity shortage is a system for directing the rescue-ready vehicle 12 to the base of the electric vehicle 11. The electric vehicle 11 is a vehicle equipped with a removable battery such as a cartridge-type battery. The rescue-ready vehicle 12 includes a rescue-ready vehicle 12A owned by a rescue company and a rescue-ready vehicle 12B owned by an individual. The rescue-ready vehicle 12 is a vehicle that may be sent to and rescue the electric vehicle 11 in response to a request for rescue from the electric vehicle 11 in a state of being out of power. The rescue-ready vehicle 12 may be a vehicle having a replacement battery or a vehicle having an external power source capable of powering the electric vehicle 11. The electric vehicle 11 and the rescue-ready vehicles 12A and 12B are transmitted information about the own vehicle to the servers 20. The server 20 manages information about the electric vehicle 11 and the rescue-ready vehicles 12A and 12B, and transmits information about rescue to the electric vehicle 10 based on the information received from the electric vehicle 10. In this description, there is a case where the electric vehicle 10 is described when not particularly distinguished from the electric vehicle 11 and the rescue-ready vehicle 12.

The electric vehicle 11 includes a motor and a battery for supplying power to the motor, and travels by the power of the battery. This battery is a removable battery. The electric vehicle 11 is a battery exchange for replacing the battery with a charged replacement battery, it is possible to external charging for storing power supplied from the external power source to the battery. When the electric vehicle 11 becomes an electricity shortage state, the electric vehicle 11 can send a rescue request to the server 20 in response to an operation by a user of the electric vehicle 11. The electricity shortage state is not limited to a state in which the power of the cartridge-type battery in the electric vehicle 11 is depleted, including a state in which the electric vehicle 11 cannot arrive by self-running to the nearest charging facility although the power of the cartridge-type battery remains. Even when the electric vehicle 11 is out of state, the car navigation device, the communication device, and ECU can be operated by the remaining electric power of the cartridge-type battery or the electric power of the auxiliary battery. Incidentally, in this description, there is a case where the electric vehicle 11 in the electricity shortage state is described as an electricity shortage vehicle.

The electric vehicle 11 transmits the electricity shortage information to the server 20 as a rescue request. Electricity shortage information includes location information, battery information, state of charge information, emergency status information, and preference company information. The location information is information of the current location of the electric vehicle 11. Battery information includes battery voltage, battery capacity, information indicating whether or not it is a detachable battery, battery shape, charging standards, and charging cables on board. The state of charge information is SOC. Emergency status information includes information that indicates one of power loss occurrence, collision accident occurrence, and emergency sickness occurrence. Preference company information includes the preference company name, information indicating whether or not to wish rescue from individuals, and the gender of the rescue personnel. Preference company information may be pre-registered. The electric vehicle 11 transmits the selection information to the server 20 after transmitting the electricity shortage information. Selection information is information selected from one of the rescue-ready vehicles 12 as a responding candidate vehicle.

A rescue-ready vehicle 12A is a vehicle managed by rescue operators and can respond to the rescue of an electricity shortage vehicle. The rescue operators include multiple operators. The rescue-ready vehicle 12A includes several rescue-ready vehicles for each rescue provider. The rescue-ready vehicle 12A transmits the rescue vehicle information to the servers 20. The rescue vehicle information transmitted by the rescue-ready vehicle 12A is information about the rescue-ready vehicle 12A, and includes location information, battery information, state of charge information, and vendor information. Location information is information on the present location of the rescue-ready vehicle 12A. Battery information is information about the batteries that 12A has, including battery voltage, battery capacity, information indicating whether or not the vehicle has a detachable battery, battery shapes, charging standards, and charging cabling on board. The state of charge information is information indicating SOC of the fixed batteries mounted on the vehicle 12A capable of responding to rescue. The information indicating whether or not the vehicle has the removable battery is the information indicating whether or not the rescue-ready vehicle 12A has the replacement battery. Replacement batteries need only be loaded on the rescue-ready vehicle 12A, and may not be mounted on the rescue-ready vehicle 12A. The company information includes the name of the company and the responding fee.

The rescue-ready vehicle 12B is a vehicle that is managed by individuals and is capable of responding to the rescue of an electricity shortage vehicle. Individuals include multiple individuals. The rescue-ready vehicle 12B includes more than one vehicle that can respond to rescue for each individual. The rescue-ready vehicle 12B transmits the rescue vehicle information to the servers 20. The rescue vehicle information transmitted by the rescue-ready vehicle 12B is information about the rescue-ready vehicle 12B, and includes location information, battery information, state of charge information, and rescue willingness information. Location information is information on the present location of the rescue-ready vehicle 12B. Battery information is information about the batteries that the rescue-ready vehicle 12B has, including battery voltage, battery capacity, information indicating whether or not the vehicle has a detachable battery, battery shapes, charging standards, and charging cabling on board. The state of charge information is information indicating SOC of the fixed batteries mounted on the rescue-ready vehicle 12B. The information indicating whether or not the vehicle has the removable battery is the information indicating whether or not the rescue-ready vehicle 12B has the replacement battery. Replacement batteries need only be loaded on the rescue-ready vehicle 12B, and may not be mounted on the rescue-ready vehicle 12B. The rescue willingness information indicates whether or not there is intention to respond to rescue. When the rescue-ready vehicles 12A and 12B are not particularly distinguished, the vehicle is described as a rescue-enabled vehicle 12.

The server 20 receives the electricity shortage information from the electric vehicle 11 and receives the rescue information from the rescue-ready vehicle 12. If the server 20 determines that the electric vehicle 11 is out of power, it can send information to the rescue-ready vehicle 12 to arrange the rescue-ready vehicle 12 toward the source of the electric vehicle 11.

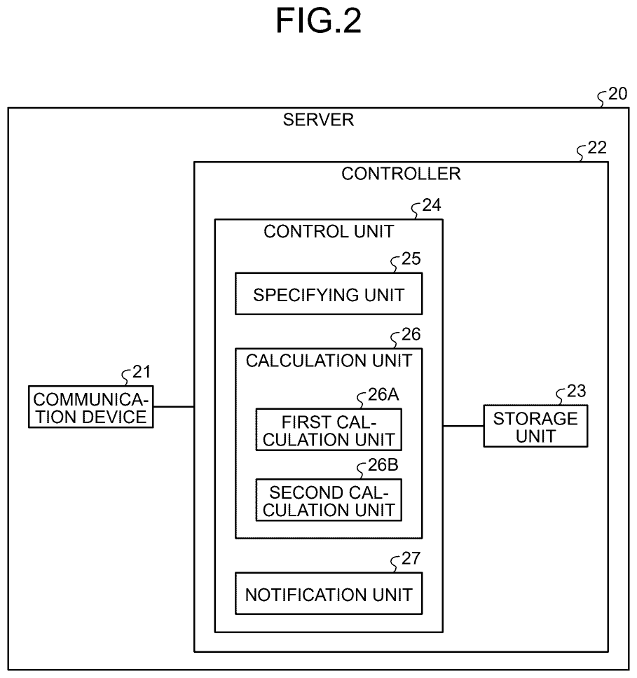

As illustrated in FIG. 2, the server 20 includes a communication device 21 and a controller 22.

The communication device 21 performs wireless communication with the electric vehicle 10. The communication device 21 transmits and receives information to and from a plurality of electric vehicle 10 via a network.

The controller 22 is an electronic controller that executes information processing. The electronic controller includes a processor and a memory. The processor is composed of CPU. Memories are composed of RAM and ROM. The controller 22 includes a storage unit 23, and a control unit 24.

The storage unit 23 stores information obtained from the electric vehicle 10. The storage unit 23 stores the electricity shortage information is information about the electric vehicle 11, and the rescue vehicle information is information about the rescue-ready vehicle 12.

The control unit 24 executes the rescue control based on the information acquired by the communication device 21 and the information stored in the storage unit 23. The rescue control is a control in which the rescue car is directed to the source of the rescue object in response to the rescue request from the train shortage. The control unit 24 includes a specifying unit 25, a calculation unit 26, and a notification unit 27.

The specifying unit 25 specifies, as responding candidate vehicles, the rescue-ready vehicle 12 that satisfies the necessary conditions for supplying power to the electric vehicle 11 based on the rescue vehicle information and the electricity shortage information. Required conditions include battery voltage, battery capacity, information indicating whether it is cartridge-type or not, battery shape, charging standard, charging cable on board, and state of charge. The specifying unit 25 specifies, as a responding candidate vehicle, the rescue-ready vehicle 12 that has a replacement battery and has the same battery shape as the battery of the electric vehicle 11 in priority from the rescue-ready vehicle 12. The specific unit 25 specifies, among the rescue-ready vehicles 12 having no replacement battery, the rescue-ready vehicles 12 satisfying the charging standard as responding candidate vehicles.

The calculation unit 26 includes a first calculation unit 26A and a second calculation unit 26B.

The first calculation unit 26A computes a travel time which is the time until the rescue-ready vehicle 12 arrives at the origin of the electric vehicle 11. The first calculation unit 26A calculates the travel times until the rescue-ready vehicle 12 arrives at the base of the electric vehicle 11 on the basis of the location information of the electric vehicle 11 in the electricity shortage condition and the location information of the rescue-ready vehicle 12.

The second calculation unit 26B calculates a work time that is the time from the arrival of the rescue-ready vehicle 12 to the completion of the power supply work to the electric vehicle 11. The second calculation unit 26B computes the working hours until the power supply to the electric vehicle 11 is completed after the responding candidate vehicle arrives at the base of the electric vehicle 11 based on the required conditions. When the responding candidate vehicle has a replacement battery, the second calculation unit 26B calculates the replacement time between the battery and the replacement battery of the electric vehicle 11 as the working time. If the responding candidate vehicle does not have a replacement battery, the second calculation unit 26B calculates a charging time from the external power supply of the responding candidate vehicle to the battery of the electric vehicle 11 is completed as a working time.

The notification unit 27 notifies the electric vehicle 11 of various information corresponding to the rescue request. The notification unit 27 notifies the rescue candidate information including the rescue vehicle information, the travel time, and the work time to the portable terminal carried by the user of the electric vehicle 11 or the electric vehicle 11 is the transmission source of the electricity shortage information.

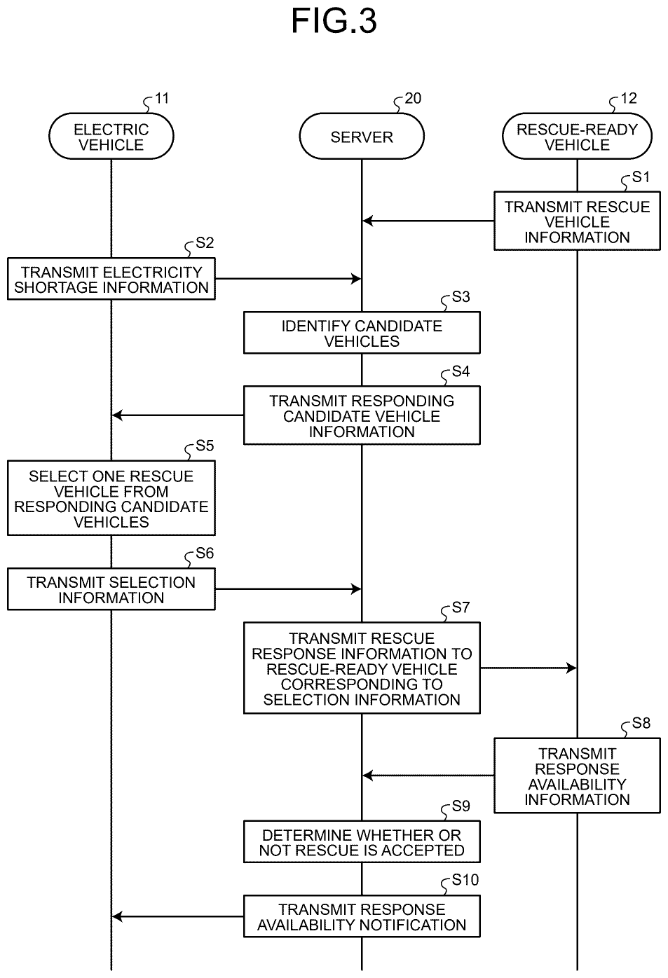

FIG. 3 is a sequence diagram illustrating a rescue process. The rescue-ready vehicle 12 transmits the rescue vehicle data to the server 20 (Step S1). In Step S1, the rescue vehicle information, which is information about the rescue-ready vehicle 12, is transmitted to the servers 20. The server 20 stores the received rescue vehicle information in the storage unit 23 when it receives the rescue vehicle information from the rescue-ready vehicle 12.

The electric vehicle 11 transmits the electricity shortage information to the server 20 (Step S2). In Step S2, a rescue request is transmitted from the electric vehicle 11 in an electricity shortage condition to the servers 20. The electricity shortage information includes emergency status information.

The server 20, when receiving the emergency state information indicating the electricity shortage occurrence from the electric vehicle 11, it grasps that the electric vehicle 11 in the electricity shortage state is present. The servers 20 identify responding candidates from the rescue-ready vehicles 12 based on the rescue vehicle information and the train shortage information (Step S3).

In Step S3, one or more rescue-ready vehicles 12 are identified that meet the requirements for powering the electric vehicle 11. When the server 20 identifies a responding candidate vehicle, it generates responding candidate vehicle information, which is information about the identified responding candidate vehicle. The server 20 preferentially identifies rescue-ready vehicles 12 that can be rescued by battery replacement. In Step S3, the servers 20 prioritize the rescue-ready vehicles 12 located close to the electric vehicles 11 based on the location information of the electric vehicles 11 and the location information of the rescue-ready vehicles 12. Based on the battery information of the electric vehicle 11 and the battery information of the rescue-ready vehicle 12, the server 20 specifies the rescue-ready vehicle 12 that satisfies the necessary conditions for supplying power to the electric vehicle 11 as the responding candidate vehicle. The server 20 prioritizes the rescue-ready vehicle 12 having the same voltage value as the electric vehicle 11 based on the battery voltage. The server 20 prioritizes the rescue-ready vehicle 12 having a removable battery based on information indicating whether it is a removable battery or not. For the rescue-ready vehicle 12 having the detachable battery, when the battery shape is the same as the battery shape of the electric vehicle 11, the server 20 determines the rescue-ready vehicle 12 as a responding candidate vehicle. For the rescue-ready vehicle 12 having no removable battery, the server 20 is identified as a responding candidate vehicle when it satisfies the charging standard and the charging cable on board.

The server 20 based on the charging standard, the charging standard that cannot be charged from the rescue-ready vehicle 12 to the electric vehicle 11 is excluded from the responding candidate vehicle.

The server 20 based on the charging cable mounted, if it can be charged to the electric vehicle 11 from the rescue-ready vehicle 12 by either one of the charging cables mounted on the rescue-ready vehicle 12 and the electric vehicle 11, the rescue-ready vehicle 12 and the responding candidate vehicle. Further, the server 20 based on the charging state information of the electric vehicle 11 and the charging state information of the rescue-ready vehicle 12, priority rescue-ready vehicle 12 which can be charged to the electric vehicle 11 is large. The server 20 calculates the rechargeable charge to the electric vehicle 11 based on SOC is battery capacity and battery status information of the battery information.

The server 20 transmits the responding candidate-vehicle information to the electric vehicle 11 (Step S4). In Step S4, the responding candidate vehicle information is transmitted to the electric vehicle 11 which is the sender of the power lack information.

When the electric vehicle 11 receives the responding candidate vehicle data, one of the responding candidate vehicles is selected to the rescue vehicle (Step S5). In Step S5, when the electric vehicle 11 receives the selection by the user of the electric vehicle 11, one of the responding candidates is selected. The responding candidate vehicle selected in the selection information is a rescue vehicle that is preference to be rescued by the user of the electric vehicle 11.

The electric vehicle 11 transmits the selected selection to the server 20 (Step S6).

Upon receiving the selection information from the electric vehicle 11, the server 20 identifies the rescue-ready vehicle 12 corresponding to the selection information and transmits the rescue-ready information to the identified rescue-ready vehicle 12 (Step S7). In Step S7, the rescue response information is transmitted from the user of the electric vehicle 11 to a single rescue-ready vehicle 12. Rescue response information includes location information, battery information, charge state information, and emergency state information in electricity shortage information.

When the rescue response information is received from the server 20, the rescue-ready vehicle 12 transmits the response availability information to the server 20 (Step 8). In Step S8, the response availability information including information indicating the availability of the rescue response is transmitted from the rescue-ready vehicle 12 to the server 20.

Servers 20, when receiving the response availability information from the rescue-ready vehicle 12, it determines whether or not the rescue is accepted (Step S9). In Step S9, it is judged whether the received response availability information is rescue acceptance and rescue rejection. When the server 20 receives the response availability information from the rescue-ready vehicle 12, it determines whether the rescue response is possible based on the response availability information.

The server 20 transmits the response availability notification to the electric vehicle 11 (Step S10). In Step S10, when the response availability information is rescue acceptance notification is transmitted to the electric vehicle 11, when the response availability information is rescue rejection failure notification is transmitted to the electric vehicle 11. If it is determined that the rescue response can be performed in S9 of steps, the notification unit 27 determines that the rescue by the responding candidate vehicle has been accepted, and notifies the rescue reception completion to the electric vehicle 11 that is the sender of the power shortage information.

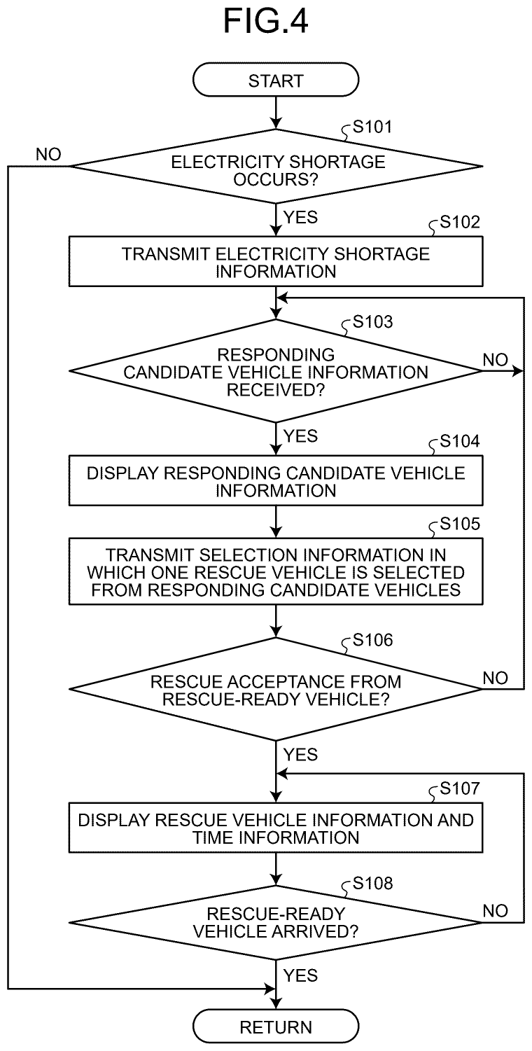

FIG. 4 is a flowchart showing information processing in an electric vehicle. Control illustrated in FIG. 3 is implemented repeatedly by the electric vehicle 11.

The electric vehicle 11 determines whether an electricity shortage has occurred (Step S101). In Step S101, it is determined whether or not the electric vehicle 11 is out of state. If the electricity shortage has not occurred (Step S101: No), the control routine ends.

If the electricity shortage occurs (Step S101: Yes), the electric vehicle 11 transmits the electricity shortage information to the server 20 (Step S102). In Step S102, the electric vehicle 11 receives the operation by the user of the electric vehicle 11, so that the electric vehicle 11 transmits the lack of power information to the server 20. The processing of Step S102 is the same as the processing of Step S2.

The electric vehicle 11 determines whether it has received the responding candidate vehicle information from the server 20 (Step S103). If the responding candidates are not received (Step S103: No), the process returns to Step S103.

When receiving the responding candidate information (Step S103: Yes), the electric vehicle 11 displays the responding candidate vehicle information to the display device receives (Step S104). In Step 104, responding candidate vehicle information is displayed on the monitor in the vehicle interior of the electric vehicle 11. It is possible to display responding candidate vehicle information to the car navigation device of the electric vehicle 11. The response candidate information includes rescue vehicle information, information indicating the expected arrival time of the rescue-ready vehicle 12, and information indicating the time required for rescue after the arrival of the rescue-ready vehicle 12. In Step S104, information that can distinguish whether the responding candidate vehicle is the external charge or the battery replacement, information indicating the travel time until the responding candidate vehicle arrives at the base of the electric vehicle 11, and information indicating the working time required for the elimination of the state shortage after the responding candidate vehicle arrives are displayed. The user of the electric vehicle 11 can grasp the total time until the electricity shortage state is resolved based on the displayed responding candidate vehicle information. Then, the user of the electric vehicle 11 inputs a selection operation to the electric vehicle 11, and selects a vehicle to be relieved from among the responding candidate vehicles.

The electric vehicle 11 transmits the selected selection data from one of the responding candidates to the server 20 (Step S105).

The electric vehicle 11 determines whether there is rescue acceptance from the rescue-ready vehicle 12 (Step S106). In Step S106, it is determined whether or not rescue by the selected responding candidate vehicle is available. The electric vehicle 11 determines whether it has received the rescue reception completion notification from the server 20. When the rescue reception completion notice is received, the electric vehicle 11 is judged to have accepted the rescue from the selected responding candidate vehicle. When the rescue reception completion notification is not received, the electric vehicle 11 determines that the rescue has been rejected from the selected responding candidate vehicle. The electric vehicle 11 determines that the rescue is denied when it receives a failure notification from the server 20.

If it is determined that the rescue has been rejected from the rescue-ready vehicle 12 (Step S106: No), the process returns to Step S103.

If it is determined that the rescue has been accepted from the rescue-ready vehicle 12 (step S106: Yes), the electric vehicle 11 displays the rescue vehicle information and the timed information on the display device (Step S107). In Step S107, the present location information of the rescue-ready vehicle 12 and the time-to-arrive information of the rescue-ready vehicle 12 are displayed on the displays of the electric vehicle 11.

The electric vehicle 11 determines whether the rescue-ready vehicle 12 has arrived (Step S108). If the rescue-ready vehicle 12 does not arrive (Step S108: No), it returns to Step S106. If the rescue-ready vehicle 12 arrives (Step S108: Yes), the control routine ends.

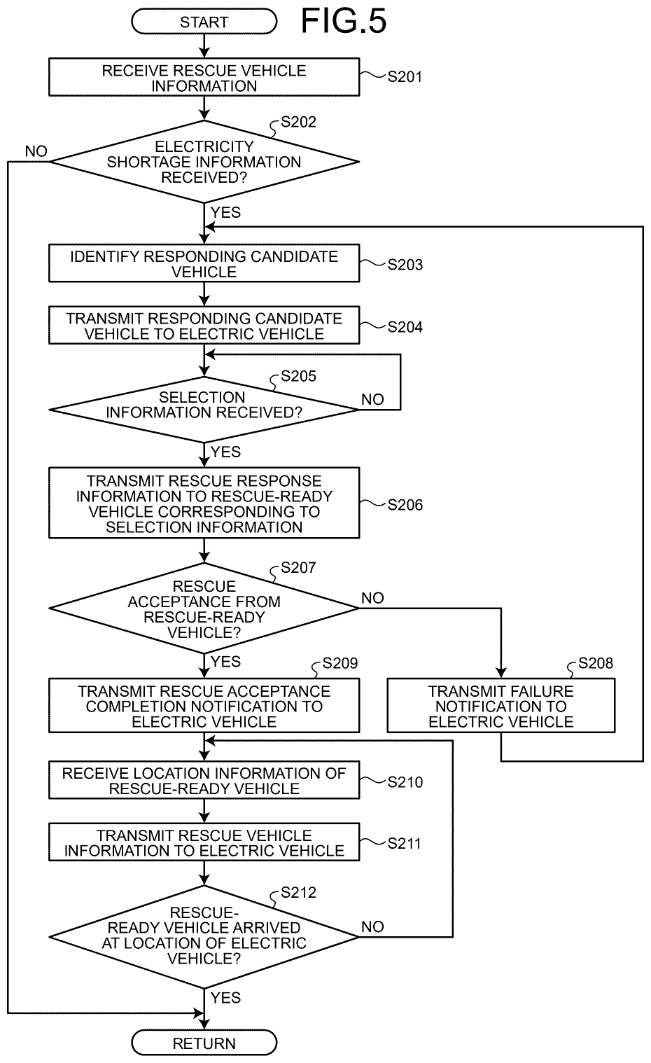

FIG. 5 is a flowchart illustrating an information processing in a server. The control illustrated in FIG. 5 is implemented repeatedly by the server 20.

The servers 20 receive rescue vehicle data (Step S201). In Step S201, the rescue vehicle information transmitted from the rescue-ready vehicle 12 are received.

The server 20 determines whether or not it has received the power-off data (Step S202). In Step S202, it is determined whether or not the electricity shortage information transmitted from the electric vehicle 11 have been received. If no electricity shortage information has been received (Step S202: No), this control is terminated.

When the electricity shortage information is received (Step S202: Yes), the servers 20 identify responding candidate vehicles based on the electricity shortage information and the rescue vehicle information (Step S203). The processing of Step S203 is the same as the processing of Step S3.

The server 20 transmits the responding candidate-vehicle information to the electric vehicle 11 (Step S204). In Step S204, the information indicating the estimated arrival time of the rescue-ready vehicle 12 and the information indicating the time required for the rescue are transmitted to the electric vehicle 11. The server 20 calculates the time required for rescue. When the battery is replaced, the standard replacement time set in advance is set to the time required for rescue. The standard replacement time is, for example, 10 minutes. If it is charging to the electric vehicle 11, the output possible value from the rechargeable amount of charge÷the rescue-ready vehicle 12, to set the time required for rescue by the time determined. The processing of Step S204 is the same as the processing of Step S4.

The server 20 determines whether or not the selection information has been received (Step S205). In Step S205, it is determined whether or not the selection information from the electric vehicle 11 have been received. When the selection information is not received (Step S205: No), the process returns to Step S205.

When the selection information is received (Step S205: Yes), the server 20 transmits the rescue response information to the rescue-ready vehicle 12 corresponding to the selection information (Step S206). The processing of Step S206 is the same as the processing of Step S7.

The servers 20 determine whether or not there is a rescue acceptance from the rescue-ready vehicle 12 (Step S207). In Step S207, the server 20 receives response availability information, which is a response from the rescue-ready vehicle 12 that sent the rescue response information, and determines whether the response availability information includes information indicating the rescue acceptance. When the received response availability information includes the information indicating that the rescue is rejected, the server 20 determines that the rescue acceptance could not be obtained from the rescue-ready vehicle 12. The processing of Step S207 is the same as the processing of Step S9.

If the rescue acceptance is not obtained from the rescue-ready vehicle 12 (Step S207: No), the server 20 determines that the rescue is denied, and transmits the failure notification to the electric vehicle 11 (Step S208). After processing Step S208, this control routine returns to Step S203.

If there is a rescue acceptance from the rescue-ready vehicle 12 (Step S207: Yes), the server 20 transmits the rescue acceptance completion notification to the electric vehicle 11 (Step S209).

The server 20 receives the location information of the rescue-ready vehicle 12 (Step S210), and transmits the rescue vehicle information to the electric vehicle 11 (Step S211). In Step S211, the present location of the rescue-ready vehicle 12, the estimated time of arrival, and the time required for rescue are transmitted to the electric vehicle 11.

The servers 20 determine whether or not the rescue-ready vehicle 12 has arrived at the base of the electric vehicle 11 (Step S212). In Step S212, based on the locational information of the electric vehicle 11 acquired by Step S201 and the locational information of the rescue-ready vehicle 12 obtained by Step S210, whether or not the rescue-ready vehicle 12 has arrived at the base of the electric vehicle 11 is determined.

If the rescue-ready vehicle 12 has not arrived at the origin of the electric vehicle 11 (Step S212: No), returns to Step S210. If the rescue-ready vehicle 12 arrives at the origin of the electric vehicle 11 (Step S212: Yes), the control routine ends.

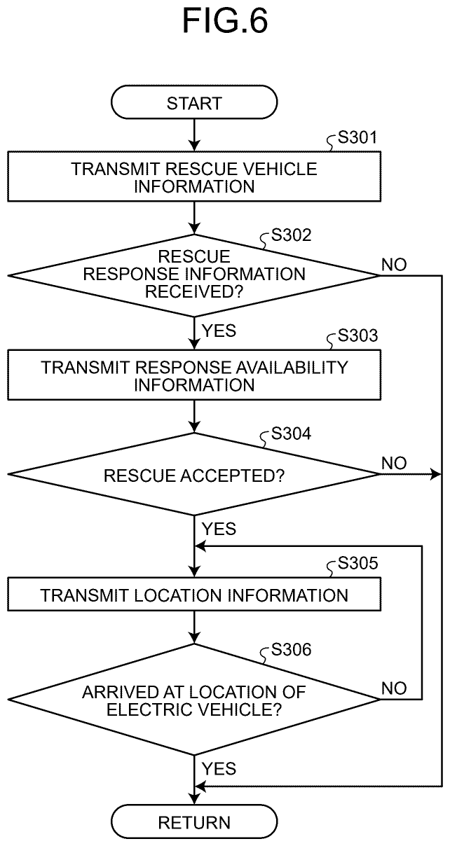

FIG. 6 is a flowchart showing a control flow in a vehicle capable of responding to rescue. The control illustrated in FIG. 6 is implemented repeatedly by the rescue-ready vehicle 12.

The rescue-ready vehicle 12 transmits the rescue vehicle data to the server 20 (Step S301). The processing of Step S301 is the same as the processing of Step S1.

The rescue-ready vehicle 12 determines whether or not the rescue response data has been received (Step S302). In Step S302, it is determined whether the rescue response information has been received from the server 20. If no rescue response is received (Step S302: No), this control is terminated.

When the rescue response information is received (Step S302: Yes), the rescue-ready vehicle 12 transmits the response availability information to the server 20 (Step S303). The processing of Step S303 is the same as the processing of Step S8.

The rescue-ready vehicle 12 determines whether or not the rescue has been accepted (Step S304). In Step S304, it is judged whether the transmitted correspondence availability information is rescue acceptance. If the rescue is not accepted (Step S304: No), the control routine ends.

If the rescue is accepted (Step S304: Yes), the rescue-ready vehicle 12 transmits the present location data to the servers 20 (Step S305).

The rescue-ready vehicle 12 determines whether it has arrived at the origin of the electric vehicle 11 (Step S306). In Step S306, it is determined whether or not the vehicle has arrived at the source of the electric vehicle 11 based on the location information of the electric vehicle 11 included in the rescue response information and the present location information of the rescue-ready vehicle 12. If the rescue-ready vehicle 12 has not arrived at the location of the electric vehicle 11 (Step S306: No), returns to Step S305. If the rescue-ready vehicle 12 arrive at the location of the electric vehicle 11 (Step S306: Yes), the control routine ends.

As described above, according to the embodiment, the user of the electric vehicle 11 in the electricity shortage state can recognize the presence or absence of the detachable battery, the time until the rescue-ready vehicle 12 arrives, and the time until the rescue is completed after the arrival at the timing of selecting the rescue vehicle. This reduces the user's concerns.

The transmission source of the electricity shortage information is not limited to the electric vehicle 11 may be a portable terminal carried by the user of the electric vehicle 11. That is, the sender of the electricity shortage information is an electric vehicle 11 or a portable terminal. The server 20 transmits the responding candidate vehicle information and failure notification and rescue acceptance completion notification to the electric vehicle 11 or the mobile terminal is the sender of the electricity shortage information.

Further, when the server 20 determines that the rescue has been rejected, it may not necessarily transmit a failure notification to the electric vehicle 11. The electric vehicle 11 or the mobile terminal can be determined that the rescue is denied when not receiving the rescue acceptance completion notification until a predetermined time has elapsed after transmitting the selection information.

Further, the electric vehicle 11 may transmit the electricity shortage information to the server 20 before the electric power is lost and disabled, and when it cannot arrive at the nearest charging facility by self-propelling. The electric vehicle 11 can transmit electricity shortage information in the event that there is a power loss expectation. At that time, a car navigation may be used to guide a place where the electric vehicle 11 that is expected to run out of power can come close to the rescue vehicle and a place where the vehicle can stop at a safe place.

According to the present disclosure, it is possible to reduce the anxiety of the user of the electric vehicle when the electric vehicle traveling by the state of the detachable battery becomes an electricity shortage.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric vehicle rescue system comprising:
an electric vehicle including a detachable battery, the detachable battery being replaceable with a replacement battery and rechargeable by storing power supplied from an external power source;
a server configured to receive a rescue request from the electric vehicle; and
rescue-ready vehicles communicatively connected to the server, each of the rescue-ready vehicles being possible to be sent to the electric vehicle in response to the rescue request, wherein
each of the rescue-ready vehicles includes the replacement battery, or the external power supply capable of charging the detachable battery of the electric vehicle, and
the server includes:
a storage unit configured to store rescue vehicle information as information about the rescue-ready vehicle, the rescue vehicle information including: location information of the rescue-ready vehicle; and information indicating presence or absence of the replacement battery;
a specifying unit configured to specify a responding candidate vehicle from the rescue-ready vehicles which satisfy a necessary condition for supplying electric power to the electric vehicle in response to reception of electricity shortage information as the rescue request, the electricity shortage information including location information of the electric vehicle and information indicating that the electric vehicle is in an electricity shortage state, and the responding candidate vehicle being specified based on the rescue vehicle information and the electricity shortage information;
a first calculation unit configured to calculate a travel time for the responding candidate vehicle to arrive at a location of the electric vehicle based on the location information of the rescue-ready vehicle and the location information of the electric vehicle;
a second calculation unit configured to calculate a work time from arrival of the rescue-ready vehicle to completion of power supply to the electric vehicle based on the necessary condition; and
a notification unit configured to notify responding candidate information including the rescue vehicle information, the travel time and the work time to a transmission source of the electricity shortage information.

2. The electric vehicle rescue system according to claim 1, wherein
the necessary condition includes: presence or absence of the replacement battery; a battery shape; and a charging standard,
the specifying unit is configured to
specify the rescue-ready vehicle which includes the replaceable battery having the same battery shape as the detachable battery as the responding candidate vehicle with priority, and
specify the rescue-ready vehicle which satisfies the charging standard from the rescue-ready vehicles without replaceable battery as the responding candidate vehicle, and
the second calculation unit is configured to
calculate, when the responding candidate vehicle includes the replaceable battery, a time for replacing the detachable battery with the replacement battery as the work time, and
calculate, when the responding candidate vehicle does not include the replaceable battery, a time for completing charging from the external power source to the detachable battery as the work time.

3. The electric vehicle rescue system according to claim 2, wherein
the transmission source of the electricity shortage information is the electric vehicle or a portable terminal of a user of the electric vehicle, and
the electric vehicle or the portable terminal which is the transmission source of the electric vehicle information is configured to
display the responding candidate vehicle information received from the server, and
transmit the selection information in which one vehicle is selected from the responding candidate vehicles included in the responding candidate vehicle information to the server.

4. The electric vehicle rescue system according to claim 3, wherein
the server is configured to transmit, when the server has received the selection information from the electric vehicle or the portable terminal, rescue response information to the rescue-ready vehicle corresponding to the responding candidate vehicle selected by the selection information, and
the rescue-ready vehicle is configured to transmit response availability information indicating acceptance or non-acceptance of rescue to the server when the rescue-ready vehicle has received the rescue response information from the server.

5. The electric vehicle rescue system according to claim 4, wherein the server is configured to
determine, when the server has received the response availability information from the rescue-ready vehicle, whether or not the rescue is possible based on the response availability information, and
determine, when it is determined that the rescue is possible, that the rescue by the rescue-ready vehicle is accepted, and notify rescue reception completion to the electric vehicle or the portable terminal which is the transmission source of the electricity shortage information.
